(19) United States
(12) Patent Application Publication
(10) Pub. No.: US 2005/0179966 A1
(43) Pub. Date: Aug. 18, 2005

(54) Hologram recording medium

(75) Inventors: Ikuo Aoki, Yokohama (JP); Yoshitaka Takahashi, Yokohama (JP)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 11/059,355

(22) Filed: Feb. 17, 2005

(30) Foreign Application Priority Data
Feb. 18, 2004 (JP) 2004-41429
Oct. 5, 2004 (KR) 10-2004-0079206

(51) Int. Cl. G03H 1/00

(52) U.S. Cl. 359/2; 359/3

(57) ABSTRACT

Provided is a hologram recording medium of precisely performing a location determination control of a beam spot by using a simple structure and performing a shift multi-recording while performing a two-dimensional location determination control in a tangential direction and a radial direction of the recording medium. The provided hologram recording medium has a recording/reproducing layer and a reflection layer between two substrates, and continuous or intermittent convex units or concave units for performing an optical location determination control are installed on a substrate adjacent to the reflection layer, the substrate having a flat surface facing the reflection layer. Accordingly, the provided hologram recording medium precisely performs a location determination control of a beam spot for recording data and performs a shift multi-recording while performing a two dimensional location determination control in a tangential direction and a radial direction of the recording medium.

### CROSS-REFERENCE TO RELATED APPLICATIONS

This application claims the priority of Japanese Patent Application No. 2004-41429, filed on Feb. 18, 2004, in the Japanese Intellectual Property Office and Korean Patent Application No. 2004-79206, filed on Oct. 5, 2004, the disclosures of which are incorporated herein in its entirety by reference.

### BACKGROUND OF THE INVENTION

1. Field of the Invention

The present invention relates to a recording medium, and, more particularly, to a hologram recording medium on which data is recorded by using interference fringes of an object beam and a reference beam.

2. Description of the Related Art

Recently, a phase shift type of an optical disk or an optical magnetic type of an optical disk is widely used as an information recording medium. In order to increase the recording density of such an optical disk, reducing the diameter of a beam spot and the distance between adjacent tracks or adjacent bits is required.

Although the recording density of an optical disk has been increased, the recording density of an optical disk is physically limited by a diffraction limit of a beam to record data on a surface. Accordingly, a three dimensional multi-recording including a depth direction is required to increase the recording density of an optical disk.

Therefore, a hologram recording medium having a large capacity due to a three dimensional multi-recording region and that may be used at a high speed due to a two dimensional recording/reproducing scheme has attracted public attention as a next generation of computer recording media. Such a hologram recording medium may be formed by inserting a recording/reproducing layer, formed of a photopolymer, between two sheets of glass. In order to record data on the hologram recording medium, an object beam corresponding to data to be recorded and a reference beam are irradiated to the hologram recording medium to form interference fringes. In order to reproduce data from the hologram recording medium, a reference beam is irradiated to the interference fringes.

Since a plurality of two dimensional data are recorded in the same region, a hologram recording medium formed in the same shape as a compact disk has a huge recording density of the order of tera-bytes. In this regard, Japanese Laid-open Patent No. 2000-268380 discloses a method of recording a location determination signal as hologram data on a hologram recording medium.

According to such a method, recording data on a front surface of a hologram recording medium is possible. However, when reproducing data from the hologram recording medium via a different recording/reproducing device, precisely determining a location thereon is difficult because a chucking deviation amount or a vibration amount of an eccentric spindle differs from one recording/reproducing device to another.

### SUMMARY OF THE INVENTION

The present invention provides a hologram recording medium that allows a location determination control of a beam spot thereon and a shift multi-recording during a two dimensional location determination control in a tangential direction and a radial direction thereof.

According to an aspect of the present invention, a hologram recording medium includes a recording/reproducing layer to record data on a first surface and an optical location determination control layer on a second surface.

Accordingly, controlling the location determination of a beam spot to record/reproduce data is possible for the hologram recording medium that includes a large capacity.

According to another aspect of the present invention, a hologram recording medium includes a recording/reproducing layer and a reflection layer between two substrates, wherein continuous or intermittent convex or concave units to perform an optical location determination control are installed on a substrate that is adjacent to the reflection layer. Here, the substrate includes a flat surface that faces the reflection layer.

Accordingly, the controlling the location determination of a beam spot so as to record/reproduce data is possible for the hologram recording medium that includes a large capacity. In addition, since the layer to record/reproduce data is flat, performing a two dimensional shift multi-recording is possible.

Data may be recorded and reproduced in a substrate direction of the recording/reproducing layer while operations of optical location determination to record and reproduce data are performed using the convex or the concave units of the substrate adjacent to the reflection layer.

Accordingly, a hologram recording medium optimum for a device having independent information recording/reproducing optical system and location determination controlling optical system may be provided.

The width of the location determination controlling convex or concave units is the same as the shift amount of a beam spot, when a shift multi-recording is performed.

The width of the location determination controlling convex or concave units is determined to be an integer multiple of the shift amount of a beam spot, when a shift multi-recording is performed.

Accordingly, a hologram recording medium for performing two-dimensional shift multi-recording/reproducing by using a simple structure is provided.

The sum of the widths of the location determination controlling convex and concave unit is similar to the shift amount of a beam spot, when a shift multi-recording is performed.

The sum of the widths of the location determination controlling convex and concave unit is determined to be an integer multiple of the shift amount of a beam spot, when a shift multi-recording is performed. Accordingly, a hologram recording medium to perform two dimensional shift multi-recording/reproducing via a simple structure is provided.

The hologram recording medium is disk shaped. Accordingly, controlling the location determination of a beam spot to record/reproduce data is possible in the hologram recording medium having a large capacity, because the hologram recording medium is in a disk shape. In addition, since the layer to record/reproduce data is flat, performing a two dimensional shift multi-recording is possible.

The hologram recording medium is card shaped. Accordingly, controlling the location determination of a beam spot to record/reproduce data is possible for the hologram recording medium having a large capacity, because the hologram recording medium has a card shape. In addition, since the layer to record/reproduce data is flat, performing a two-dimensional shift multi-recording is possible.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are sectional views of hologram recording media according to embodiments of the present invention;

FIG. 2 illustrates a hologram recording medium according to an embodiment of the present invention;

FIG. 3 is a sectional view of a hologram recording medium according to an embodiment of the present invention for illustrating the width of a concave unit or a convex unit for a location determination; and

FIG. 4 illustrates a scheme of recording data by a two-dimensional shift multi recording.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

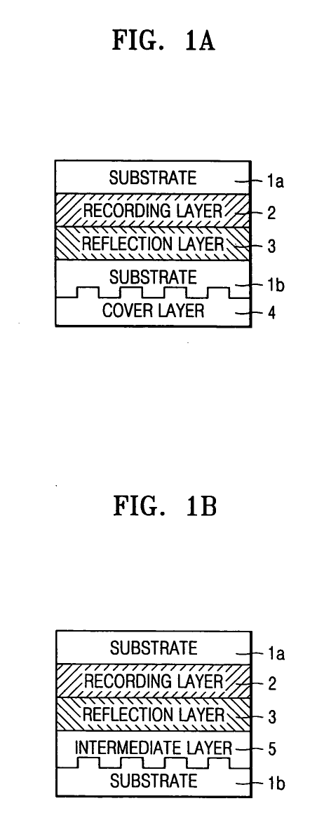

FIGS. 1A and 1B are sectional views of hologram recording media according to embodiments of the present invention.

Referring to FIG. 1A, a hologram recording medium according to the first embodiment of the present invention includes a substrate 1a, a recording/reproducing layer 2, a reflection layer 3, a substrate 1b, and a cover layer 4. In order to record/reproduce data on/from the hologram recording medium, an information recording/reproducing optical system is arranged on the upper portion of the substrate 1a. A beam spot, in other words, an object beam and a reference beam, is then irradiated from the information recording/reproducing optical system. Accordingly, interference fringes formed by the object beam and the reference beam are recorded on the recording/reproducing layer 2. The substrate 1b and the cover layer 4 arranged under the reflection layer 3 are not used when reproducing data.

Meanwhile, concave u or convex units are formed on a surface of the substrate 1b opposite from the reflection layer 3. When the hologram recording medium is disk shaped, the concave or the convex units may be formed in a spiral shape or a circular shape similar to the track grooves of an optical disk.

In addition, the cover layer 4 arranges a location determination controlling optical system on the concave or the convex units of the substrate 1b to irradiate a beam spot to the concave or the convex units so as to conveniently perform the detection of the location determination and the control of the location determination. The cover layer 4 physically protects the concave or the convex units of the substrate 1b from the outside. Referring to FIG. 1B, an intermediate layer 5 may be formed under a reflection layer 3, and a substrate 1b having concave or convex units may be arranged under the intermediate layer 5. Of, course, although not shown, this embodiment may also include a cover layer as in the embodiment shown in FIG. 1A. Furthermore, a hologram recording medium may be formed in different shapes as long as a recording/reproducing layer is arranged to face a location control layer.

In another case, a location determination control in an information recording/reproducing optical system may be relatively simply formed by connecting the information recording/reproducing optical system and a location determination controlling optical system to relatively precisely control the location determination controlling optical system.

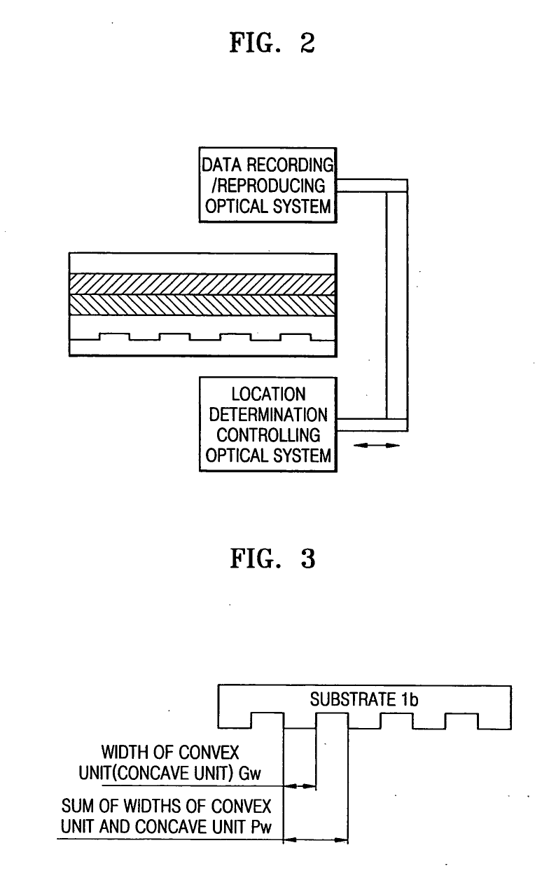

Such a structure is shown in FIG. 2, wherein an information recording/reproducing optical system and a location determination controlling optical system are physically connected. Of course, the information recording/reproducing optical system and the location determination controlling optical system may also be physically separated. In such a case, a control signal is fed back from the location determination controlling optical system to both the information recording/reproducing optical system and the location determination controlling optical system in order to control the location determination of the optical systems.

The width of concave or convex units formed on the substrate 1b will now be described with reference to FIG. 3.

A hologram recording medium according to the embodiments of the present invention discussed above includes a structure that enables a location determination control and includes a substrate 1a, a recording/reproducing layer 2, and a reflection layer 3 having a flat surface. Accordingly, when performing a shift multi-recording operation, relatively precise recording/reproducing of data in a radial direction of the hologram recording medium is possible. Further, relatively precisely recording/reproducing data in a tangential direction is also possible. In other words, performing a shift multi-recording in two dimensions while controlling the location determination is possible.

The location determination control is performed based on information provided by the concave or the convex units of the substrate 1b. However, the information recording/reproducing optical system, whose location is determined by being connected to the location determination controlling optical system, may record/reproduce data while automatically shifting in a radial direction. This is done by establishing the width of the concave or the convex units as being substantially similar to the radial directional shift amount of a beam spot when recording/reproducing data. In this case, the width of any one of the concave and the convex units is referred to as Gw, and the sum of the widths of the concave and the convex units is referred to as Pw, as shown in FIG. 3.

In general, the radial directional shift amount Xs may be substantially equal to Pw where the location determination control is performed based on any one of the concave and the convex units. However, where the location determination control is performed by sequentially using the concave and the convex units, the radial directional shift amount Xs may be substantially equal to Gw.

In addition, a tangential directional shift amount is determined to be substantially the same as the radial directional shift amount Xs. Further, conveniently realizing the tangential directional shift amount is possible by using the rotation control of a recording medium and an information recording control system. In this case, a conventional push-pull method, which is used for a CD and a DVD, may be applied for the location determination control.

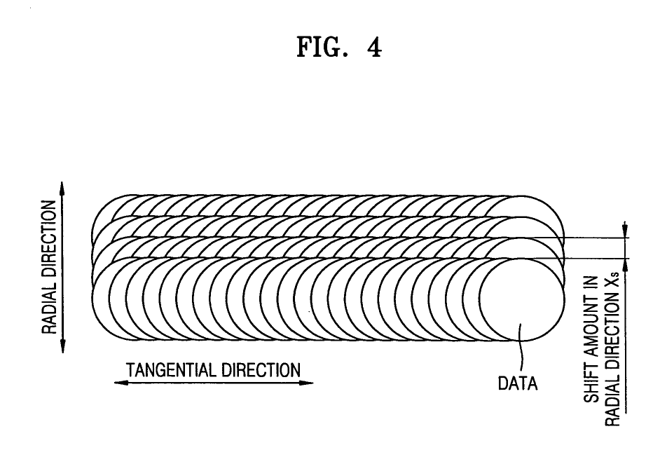

FIG. 4 illustrates a scheme of performing recording/reproducing data via a two-dimensional shift multi-recording in a tangential direction and a radial direction of a hologram recording medium. Such a scheme may be applied to a card type recording medium, as well as a disk type recording medium.

As is described above, in a hologram recording medium according to the present invention, the location determination control of a beam spot may be realized via a simple structure, and a two-dimensional shift multi-recording in a tangential direction and a radial direction of a recording medium may be performed substantially simultaneously.

Although a few embodiments of the present invention have been shown and described, it would be appreciated by those skilled in the art that changes may be made in these embodiments without departing from the principles and spirit of the invention, the scope of which is defined in the claims and their equivalents.

1. A hologram recording medium having a recording/reproducing layer to record data on one surface and an optical location determination control layer on other surface.

2. A hologram recording medium having a recording/reproducing layer and a reflection layer between two substrates, wherein continuous or intermittent convex or concave units of an optical location determination control are on the one of the substrates which is adjacent to the reflection layer, the substrate having a flat surface to face the reflection layer.

3. The hologram recording medium of claim 2, wherein data is recorded and reproduced on the recording/reproducing layer while the optical location determination to record and reproduce operations is performed by the convex or the concave units of the substrate adjacent to the reflection layer.

4. The hologram recording medium of claim 2, wherein a width of the each of the location determination controlling convex or concave units is the same as a shift amount of a beam spot, when a shift multi-recording is performed.

5. The hologram recording medium of claim 2, wherein a sum of the widths of the location determination controlling convex and concave units is the same as a shift amount of a beam spot, when a shift multi-recording is performed.

6. The hologram recording medium of claim 2, wherein a width of each of the location determination controlling convex or concave units is determined by multiplying an integer to a shift amount of a beam spot, when a shift multi-recording is performed.

7. The hologram recording medium of claim 2, wherein a sum of the widths of the location determination controlling convex and concave units is determined by multiplying an integer to a shift amount of a beam spot, when a shift multi-recording is performed.

8. The hologram recording medium of claim 2, wherein the medium is disk shaped.

9. The hologram recording medium of claim 2, wherein the medium is card shaped.

10. A medium, comprising:
a first substrate on which an information recording/reproducing optical system is arranged, the information recording/reproducing optical system being irradiated by an object beam and a reference beam;
a recording/reproducing layer adjacent to the first substrate on which the object beam and the reference beam form interference fringes;
a second substrate adjacent to the recording/reproducing layer having a surface on which concave or convex units are formed to provide location determination information; and
a cover layer adjacent to the second substrate to arrange a location determination controlling optical system in a position such that the location determination information is detected and the location determination is controlled.

11. The medium according to claim 10, further comprising a reflection layer adjacent to the recording/reproducing layer.

12. The medium according to claim 10, wherein the medium is disk shaped and the concave or the convex units are spirals or circles.

13. The medium according to claim 10, wherein the location determination controlling optical system irradiates a beam spot to the concave or the convex units so as to perform the detection of the location determination information and the control of the location determination.

14. The medium according to claim 10, wherein the cover layer protects the concave or the convex units of the second substrate.

15. The medium according to claim 11, further comprising an intermediate layer adjacent to the reflection layer and the second substrate.

16. The medium according to claim 10, wherein
performing a shifting multi-recording operation, relatively precisely recording/reproducing data in a radial direction of the medium is possible, and
performing a shifting multi-recording operation, relatively precisely recording/reproducing data in a tangential direction of the hologram recording medium is possible.

17. The medium according to claim 16, wherein the width of each of the concave or the convex units is established as being substantially similar to the radial directional shift amount of a beam spot when recording/reproducing data.

18. The medium according to claim 16, wherein a sum of the widths of the concave and the convex units may be substantially equal to a radial directional shift amount where the location determination control is performed based on any one of the concave and the convex units.

19. The medium according to claim 16, wherein where the location determination control is performed by sequentially using the concave and the convex units, a radial directional shift amount may be substantially equal to the width of the concave or the convex units.

20. The medium according to claim 16, wherein a tangential directional shift amount is determined to be substantially the same as a sum of the widths of the concave and the convex units.

21. A medium, comprising:
a first substrate on which an information recording/reproducing optical system is arranged, the information recording/reproducing optical system being irradiated by an object beam and a reference beam;
a recording/reproducing layer adjacent to the first substrate on which the object beam and the reference beam form interference fringes;
a second substrate adjacent to the recording/reproducing layer having a surface on which concave or convex units are formed to provide location determination information; and
a cover layer adjacent to the second substrate to arrange a location determination controlling optical system in a position such that the location determination information is detected and the location determination is controlled, wherein the information recording/reproducing optical system and the location determination controlling optical system are connected.

22. The medium according to claim 21, wherein the connection between the information recording/reproducing optical system and the location determination controlling optical system is physical.

23. The medium according to claim 21, wherein the connection between the information recording/reproducing optical system and the location determination controlling optical system comprises a physical separation.

24. The medium according to claim 23, wherein a control signal is fed back from the location determination controlling optical system to both the information recording/reproducing optical system and the location determination controlling optical system in order to control the location determination of the optical systems.

25. The medium according to claim 21, wherein
performing a shifting multi-recording operation, relatively precisely recording/reproducing data in a radial direction of the medium is possible, and
performing a shifting multi-recording operation, relatively precisely recording/reproducing data in a tangential direction of the hologram recording medium is possible.

26. The medium according to claim 25, wherein the widths of the concave or the convex units is established as being substantially similar to the radial directional shift amount of a beam spot when recording/reproducing data.

27. The medium according to claim 25, wherein a sum of the widths of the concave and the convex units may be substantially equal to a radial directional shift amount where the location determination control is performed based on any one of the concave and the convex units.

28. The medium according to claim 25, wherein where the location determination control is performed by sequentially using the concave and the convex units, a radial directional shift amount may be substantially equal to the width of the concave or the convex units.

29. The medium according to claim 25, wherein a tangential directional shift amount is determined to be substantially the same as a sum of the widths of the concave and the convex units.

30. A medium, comprising:
a first substrate on which an information recording/reproducing optical system is arranged, the information recording/reproducing optical system being irradiated by an object beam and a reference beam;
a recording/reproducing layer adjacent to the first substrate on which the object beam and the reference beam form interference fringes;
a second substrate adjacent to the recording/reproducing layer having a surface on which concave or convex units are formed to provide location determination information; and
a cover layer adjacent to the second substrate to arrange a location determination controlling optical system in a position such that the location determination information is detected and the location determination is controlled, wherein when performing a shift multi-recording operation, relatively precisely recording/reproducing data in radial/tangential directions of the hologram recording medium is possible.
